(19) United States
(12) Patent Application Publication
(10) Pub. No.: US 2019/0373845 A1
(43) Pub. Date: Dec. 12, 2019

(54) CONTROL DEVICE, ANIMAL TOILET, INFORMATION PROCESSING DEVICE, INFORMATION PROCESSING TERMINAL, AND CONTROL METHOD

(71) Applicant: SHARP KABUSHIKI KAISHA, Sakai City (JP)

(72) Inventors: SHIGEFUMI URATA, Sakai City (JP); KOHJI HOTTA, Sakai City (JP)

(21) Appl. No.: 16/431,273

(22) Filed: Jun. 4, 2019

(30) Foreign Application Priority Data
Jun. 8, 2018 (JP) 2018-110678

(51) Int. Cl. A01K 1/01; A01K 29/00; G06F 9/54; G06Q 10/08

(52) U.S. Cl. CPC A01K 1/0107; G06Q 10/087; G06F 9/542; A01K 29/005

(57) ABSTRACT

A control device includes: a detecting section which detects replacement of an absorbing sheet that is a sheet used for a pet toilet; a counting section which counts the replacement of the absorbing sheet; and a notification processing section which causes a user to be notified of information on the absorbing sheet kept in stock, depending on the number of times of the replacement.

This Nonprovisional application claims priority under 35 U.S.C. § 119 on Patent Application No. 2018-110678 filed in Japan on Jun. 8, 2018, the entire contents of which are hereby incorporated by reference.

### TECHNICAL FIELD

The present invention relates to a control device, a toilet, an information processing device, an information processing terminal, and a control method.

### BACKGROUND ART

In recent years, animal toilets capable of measuring a body weight of a pet or a weight of excreta of the pet have been known. According to this kind of animal toilet, a water-absorbing sheet is, for example, laid, and it is possible to keep the animal toilet clean by replacing the water-absorbing sheet in a case where a pet, for example, urinates.

Patent Literature 1 discloses a refrigerator having a consumable item replacement requesting function which is a function of (i) accumulating time of use of a consumable item used for the refrigerator and (ii) notifying a user of time to replace the consumable item, in a case where the time of use of the consumable item becomes greater than replacement requesting time. This allows the refrigerator, having the consumable item replacement requesting function, to send a notification to a user by outputting a consumable item replacement requesting signal, and thereby allows the refrigerator to request, depending on deterioration of a consumable item, replacement of the consumable item.

### CITATION LIST

### Patent Literature

[Patent Literature 1]

Japanese Patent Application. Publication, Tokukai, No. 2005-114205

### SUMMARY OF INVENTION

### Technical Problem

A user of the animal toilet needs to keep, in stock, a certain number of consumable items (for example, water-absorbing sheets) for replacement so that the user can promptly replace a consumable item with another when time to replace the consumable item comes. However, according to the technique disclosed in Patent Literature 1, although the user can grasp time to replace the consumable item that is being used, the user has to grasp, by him-/herself, how many consumable items for replacement are left in stock. In a case where a consumable item for replacement becomes out of stock, the following inconvenience is caused. That is, it becomes impossible to use the animal toilet until the user purchases the consumable item.

One or more aspects of the present invention have been made in view of the above conventional problem, and it is an object of the one or more aspects of the present invention to provide a control device, a toilet, an information processing device, an information processing terminal, and a control method, each of which prevents a consumable item for replacement from becoming out of stock.

### Solution to Problem

In order to attain the above object, a control device in accordance with an aspect of the present invention is a control device which controls an animal toilet, the control device including: a detecting section which detects replacement of a consumable item that is an item used for the animal toilet; a counting section which counts the replacement of the consumable item; and a notification processing section which causes a user to be notified of information on the consumable item kept in stock, depending on the number of times of the replacement.

A control method in accordance with an aspect of the present invention is a method of controlling an animal toilet, the method including: a detecting step of detecting replacement of a consumable item which is an item used for the animal toilet; a counting step of counting the replacement of the consumable item; and a notification processing step of causing a user to be notified of information on the consumable item kept in stock, depending on the number of times of the replacement.

### Advantageous Effects of Invention

According to one or more aspects of the present invention, it is possible to prevent a consumable item for replacement from being out of stock.

### BRIEF DESCRIPTION OF DRAWINGS

FIG. 1A is a perspective view illustrating a configuration of a pet toilet in accordance with Embodiment 1. FIG. 1B is an exploded perspective view illustrating the configuration of the pet toilet.

FIG. 2 is a cross-sectional view illustrating the configuration of the pet toilet.

FIG. 3 is a block diagram illustrating a configuration of the pet toilet, a smartphone, and a server.

FIG. 4 is a view illustrating how the number of consumable items kept in stock is counted on the basis of a measured value outputted from the pet toilet in accordance with Embodiment 1.

FIG. 5 is a view illustrating a flow along which a notification processing section of a control device in accordance with Embodiment 1 causes a notification to be sent to the user.

FIG. 6 is a flowchart illustrating a flow of a process carried out by the control device in accordance with Embodiment 1.

FIG. 7 is a block diagram illustrating a configuration of a pet toilet, a smartphone, and a server in accordance with Embodiment 2.

FIG. 8 is a view illustrating a flow along which a control device in accordance with Embodiment 2 registers the number of consumable items kept in stock.

FIG. 9 is a flowchart illustrating a flow of a process carried out by the control device in accordance with Embodiment 2.

FIG. 10 is a block diagram illustrating a configuration of a pet toilet, a smartphone, and a server in accordance with Embodiment 3.

FIG. 11 is a flowchart illustrating a flow of a process carried out by a control device in accordance with Embodiment 3.

FIG. 12 is a block diagram illustrating a configuration of a pet toilet, a smartphone, and a server in accordance with Embodiment 4.

FIG. 13 is a block diagram illustrating a configuration of a pet toilet, a smartphone, and a server in accordance with another aspect of Embodiment 4.

### DESCRIPTION OF EMBODIMENTS

### Embodiment 1

(Configuration of Pet Toilet 1)

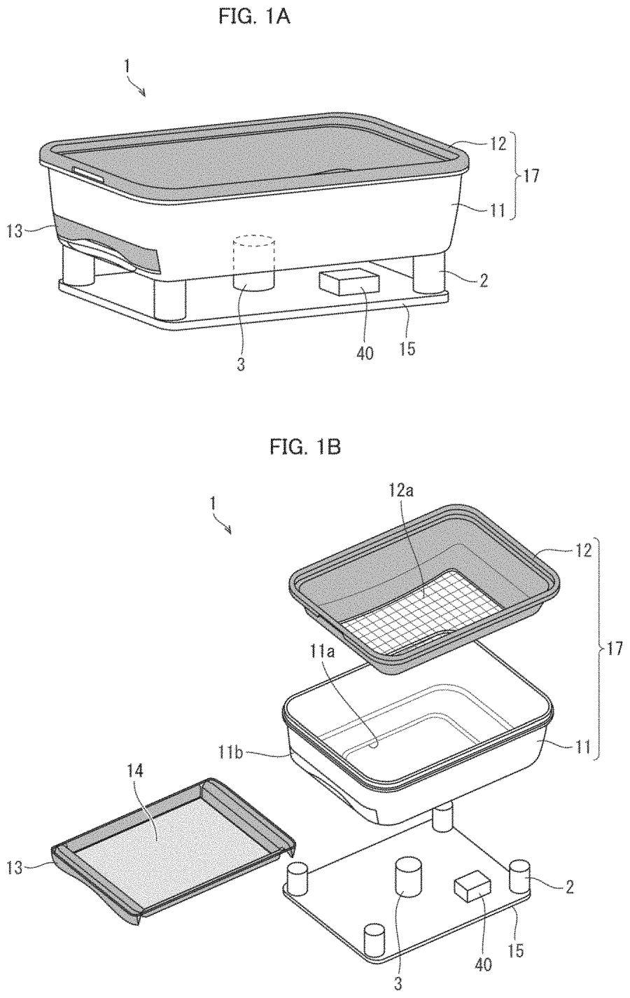

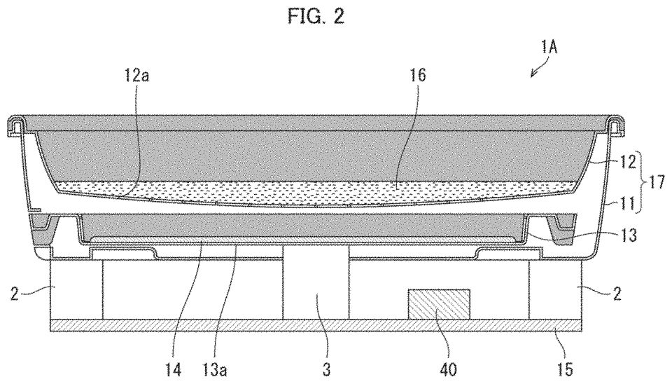

FIG. 1A is a perspective view illustrating a configuration of a pet toilet 1 in accordance with Embodiment 1. FIG. 1B is an exploded perspective view illustrating the configuration of the pet toilet 1. FIG. 2 is a cross-sectional view illustrating the configuration of the pet toilet 1.

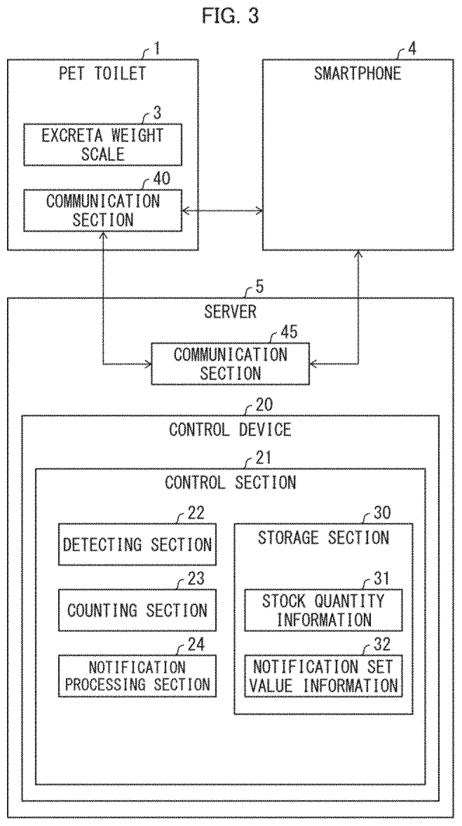

The pet toilet 1 has a function of a weight measuring device which measures a body weight of a pet, which is an animal, and a weight of excreta of the pet. The pet toilet 1 has a function of, for example, measuring a body weight of a pet and measuring a weight of excreta of the pet. Besides, the pet toilet 1 has a communication function of outputting a measured weight to a server 5 (FIG. 3). Examples of the pet which uses the pet toilet 1 include animals kept at home, such as cats and dogs. Note, however, that a toilet in accordance with an aspect of the present invention is not necessarily limited to animals such as cats and dogs, and can be applied to the other animals. For example, the toilet in accordance with an aspect of the present invention can be applied to a human. Moreover, the excreta can be urine or can be alternatively feces.

As illustrated in FIG. 1A, FIG. 1B, and FIG. 2, the pet toilet 1 includes a main container 11, an excretion stage 12, an excreta tray 13, an absorbing sheet 14, a supporting plate 15, body weight scales 2, an excreta weight scale (weight scale) 3, a communication section 40, and a cover (not illustrated). Note that the main container 11 and the excretion stage 12 may be collectively referred to as an upper unit 17.

The main container 11 supports the excretion stage 12. The excretion stage 12 is a stage onto which the pet steps and on which the pet excretes. The excretion stage 12 has, on its bottom surface, a mesh part 12a. The mesh part 12a allows a liquid to pass therethrough, but does not allow, for example, feces and an object (toy), which is brought by an animal, to pass therethrough. The mesh part 12a can be formed from a liquid permeable cloth, a liquid permeable thin film, or the like. The excretion stage 12 can alternatively have a hole through which the excreta pass, instead of the mesh part 12a. According to Embodiment 1, the excretion stage 12 is a container having a depressed shape. However, the excretion stage 12 can have any shape, provided that the excretion stage 12 allows the animal to step onto the excretion stage 12. Note that, in a case where the pet is a cat, litter 16 onto which the cat steps can be laid on the mesh part 12a, as illustrated in FIG. 2. This litter 16 for a cat is disposed of and replaced with new litter 16, in a case where excreta of the cat adhere to the litter 16. Thus, the litter 16 is a consumable item used for the pet toilet 1. Thus, a user needs to keep, in stock, a certain amount of litter 16 for replacement.

The excreta of the pet pass through the litter 16, and drops on the absorbing sheet 14 laid on a bottom plate of the excreta tray 13. The excreta tray 13 is a member which is disposed under the excretion stage 12 and which receives the excreta. The excreta tray 13 can be inserted into and drawn out from a side hole formed in a side surface of the main container 11.

The absorbing sheet 14 is a sheet which absorbs a liquid such as urine. The absorbing sheet 14 is convenient in that, after the absorbing sheet 14 absorbs a liquid such as urine, the absorbing sheet 14 can be disposed of and replaced with a new absorbing sheet 14. In other words, the absorbing sheet 14 is a consumable item used for the pet toilet 1. Thus, the user needs to keep, in stock, a certain number of absorbing sheets 14 for replacement. The supporting plate 15 is a base plate which supports the body weight scales 2, the excreta weight scale 3, and the communication section 40.

According to Embodiment 1, the body weight scales 2 are provided at, for example, respective four corners of a rectangular bottom part of the main container 11 so that the body weight scales 2 support the rectangular bottom part of the main container 11. The body weight scales 2 include respective load cells (not illustrated). As such, the body weight scales 2 measure a total weight of the main container 11, in which the excretion stage 12 is disposed, and the pet by the load cells. As a result, it is possible to measure the body weight of the pet by subtracting a weight of the main container 11, in which the excretion stage 12 is disposed, from the total weight. Note that, according to Embodiment 1, four body weight scales 2 are provided. With use of the load cells included in the respective four body weight scales 2, a Wheatstone bridge circuit can be constituted.

The excreta weight scale 3 measures the weight of the excreta of the pet by a load cell (not illustrated). According to Embodiment 1, the excreta weight scale 3 is provided at the middle of the supporting plate 15 having a rectangular shape. According to Embodiment 1, the excreta weight scale 3 is provided on the supporting plate 15 so that an upper surface of the excreta weight scale 3 is in contact with the bottom plate of the excreta tray 13. This causes the excreta tray 13, on which the absorbing sheet 14 is laid, to be supported at a single point. As a result, it is possible to measure a weight of urine, which is the excreta of the pet, by subtracting (i) a value of a weight of the absorbing sheet 14 which has riot been used yet and (ii) a value of the weight of the excreta tray 13, from a value measured by the excreta weight scale 3. According to Embodiment 1, the excreta weight scale 3 is provided on the supporting plate 15. Note, however, that a location of the excreta weight scale 3 is not limited to such a location. The value measured by the excreta weight scale 3 is outputted to the server (see FIG. 3) via the communication section 40.

Note that, according to Embodiment 1, the body weight scales 2 and the excreta weight scale 3 include the respective load cells (not illustrated) each serving as a load sensor. A load cell detects, as a change in voltage, a change in resistance value which change is caused by a strain. Note, however, that, according to an aspect of the present invention, the body weight scales 2 and the excreta weight scale 3 are each not necessarily limited to the load cell, and a weight scale of an electromagnetic force balancing type can be, for example, alternatively used. The weight scale of an electromagnetic force balancing type is configured so as to balance up a balance by an electromagnetic force and detect an electric current at that time.

Note also that the pet toilet 1 in accordance with Embodiment 1 is described on the premise that the body weight scales 2 measure a weight of the upper unit 17 and the excreta weight scale 3 measures the weight of the excreta tray 13. Note, however, that the pet toilet 1 can be configured such that any one of (i) the body weight scales 2 and (ii) the excreta weight scale 3 measures a total weight of the upper unit 17 and the excreta tray 13. In this case, it is possible to omit unused one of (i) the body weight scales 2 and (i) the excreta weight scale 3.

(Configuration of Control Device)

FIG. 3 is a block diagram illustrating a configuration of the pet toilet 1, a smartphone 4, and the server 5 in accordance with Embodiment 1. The pet toilet 1 at least includes the above-described excreta weight scale 3 and the above-described communication section 40. The server 5 includes a communication section 45 and a control device 20. The control device 20 includes a control section 21 and a power source section (not illustrated). The control section 21 includes a detecting section 22, a counting section 23, a notification processing section 24, and a storage section 30. Note that the control section 21 can further include an amplifier (AMP), an analog-to-digital converter (ADC), and/or the like.

The communication section 40 of the pet toilet 1 conducts wireless communication with the server 5 via a telecommunication line such as the Internet. The communication section 40 of the pet toilet 1 can conduct communication with the smartphone 4 via a telecommunication line such as the Internet or can alternatively conduct near field communication such as Bluetooth (registered trademark) with the smartphone 4. The server 5 is, for example, a cloud server. The server 5 can be constituted by a single information processing device or can be alternatively constituted by a plurality of information processing devices. The communication section 45 of the server 5 conducts communication with the pet toilet 1 and with the smartphone 4 via a telecommunication line such as the Internet. The smartphone 4 is one example of an information processing terminal which the user carries with him/her and uses so as to conduct communication with the pet toilet 1. The information processing terminal is not particularly limited to a smartphone, and can be alternatively a typical mobile phone, a tablet terminal, a PC (Personal Computer), or the like.

The detecting section 22 obtains, via the communication sections 40 and 45, information indicating the value measured by the excreta weight scale 3 of the pet toilet 1, and stores, over time, such a measured value thus obtained in the storage section 30. Furthermore, on the basis of the measured value thus obtained, the detecting section 22 detects replacement of the absorbing sheet 14, which is a consumable item used for the pet toilet 1. Note that the detecting section 22 can obtain, via the communication sections 40 and 45, information indicating a value measured by the body weight scales 2 of the pet toilet 1 and store, over time, such a measured value thus obtained in the storage section 30. The detecting section 22 can then detect replacement of the litter 16, which is a consumable item used for the pet toilet 1, on the basis of the measured value thus obtained.

A case will be considered where the pet toilet includes a detecting sensor which detects detachment of the excreta tray 13 from the main container 11. In this case, the detecting section 22 can detect the detachment of the excreta tray 13 from the main container 11, on the basis of, not the value measured by the excreta weight scale 3, but information which is outputted from the detecting sensor and which indicates the detachment of the excreta tray 13 from the main container 11. Then, in this case, the detecting section 22 can detect the replacement of the absorbing sheet 14 which is laid on the excreta tray 13, in a case where the detecting section 22 detects the detachment of the excreta tray 13 from the main container 11.

A case will be considered where the pet toilet 1 includes a detecting sensor which detects detachment of the excretion stage 12 or the upper unit 17. In this case, the detecting section 22 can detect the detachment of the excretion stage 12 or the upper unit 17, on the basis of, not the value measured by the body weight scales 2, but information which is outputted from the detecting sensor and which indicates the detachment of the excretion stage 12 or the upper unit 17. Then, in this case, the detecting section 22 can detect the replacement of the litter 16 which is laid on the excretion stage 12, in a case where the detecting section 22 detects the detachment of the excretion stage 12 or the upper unit 17.

The counting section 23 counts replacement of a consumable item which replacement is made in the pet toilet 1. That is, in a case where the detecting section 22 detects the replacement of the consumable item, which is used for the pet toilet 1, the counting section 23 counts this detection. The counting section 23 then stores the number of counts in the storage section 30. Further, in a case where the number of consumable items kept in stock, which number is stored in the storage section 30, increases, the counting section 23 resets the number of counts which have been done, thereby returning the number of counts to 0 (zero).

The notification processing section 24 causes the user to be notified of information on the consumable item kept in stock, depending on the number of times of the replacement of the consumable item. Specifically, in a case where the number of consumable items kept in stock, which number is indicated by stock quantity information 31, decreases to a notification set value indicated by notification set value information 32, the notification processing section 24 causes the user to be notified of a fact that a smaller number of consumable items are kept in stock. Alternatively, the notification processing section 24 can cause the user to be notified of a situation in which the number of consumable items kept in stock gradually decreases from an initial value.

Examples of a process carried out by the notification processing section 24 so as to cause such a notification to be sent to the user include: causing, via the communication section 45, the smartphone 4 to carry out given display on its display screen; causing, via the communication section 45, the smartphone 4 to produce a sound through a speaker; and causing, via the communication section 45, the smartphone 4 to vibrate. Alternatively, in a case where the pet toilet 1 includes an LED, the notification processing section 24 causes, via the communication section 45, the pet toilet 1 to light up or blink the LED. In a case where the pet toilet 1 includes a display screen, the notification processing section 24 causes the pet toilet 1 to carry out given display on the display screen. In a case where the pet toilet 1 includes a speaker, the notification processing section 24 causes the pet toilet 1 to produce a sound through the speaker.

The storage section 30 stores therein various kinds of information necessary for operation of the control section 21. Furthermore, the storage section 30 stores therein, as the stock quantity information 31, information indicating the number of consumable items which are used for the pet toilet 1 and which are kept in stock by the user. The number of consumable items kept in stock by the user indicates, for example, the number of absorbing sheets 14 kept in stock and/or the number of grams of remaining litter 16. Furthermore, the storage section 30 stores therein, as the notification set value information 32, information indicating the notification set value which is any set value that is set by the user. The notification set value is a set value in accordance with which the notification processing section 24 causes the notification to be sent to the user in a case where the stock quantity information 31 indicates that a smaller number of consumable items are left in stock. Note that the various kinds of information stored in the storage section 30 can be obtained by the control device 20 from a storage device which is not included in the server 5, and can be stored in the storage section 30.

(Method of Detecting Replacement of Consumable Item)

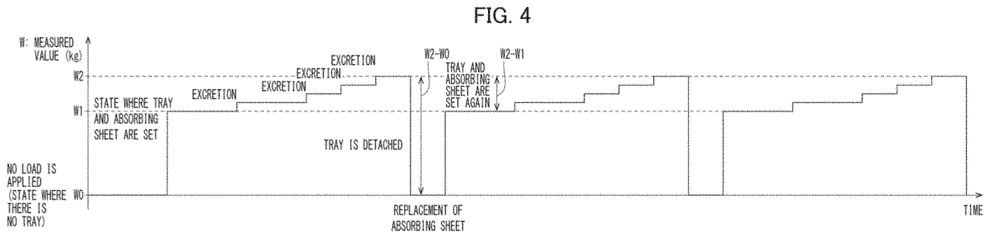

FIG. 4 is a view illustrating how the control device 20 in accordance with Embodiment 1 detects the replacement of the consumable item which is used for the pet toilet 1. The following description will discuss an example of how the detecting section 22 detects the replacement of the absorbing sheet 14, which is a consumable item used for the pet toilet 1, in accordance with a change, with time, in value which is measured by the excreta weight scale 3 and which is outputted from the pet toilet 1.

The detecting section 22 monitors the change, with time, in value which is measured by the excreta weight scale 3 and which is inputted from the pet toilet 1 via the communication sections 40 and 45. It is assumed that the value measured by the excreta weight scale 3 is represented by W (kg). It is also assumed that a measured value W which is measured in a state where the excreta tray 13 is detached from the main container 11 and a load is therefore not applied to the excreta weight scale 3 (state where no load is applied) is represented by an initial measured value W0. The measured value W, which is measured by the excreta weight scale 3, is set in advance so that the initial measured value W0 is 0 (zero) (kg).

Note, here, that a first threshold M1 and a second threshold M2 are set in advance in the detecting section 22 by, for example, an input from the user. The first threshold M1 is a threshold in accordance with which the detecting section 22 recognizes that the excreta tray 13 on which the absorbing sheet 14 to be instantly replaced is laid has been detached fromm the main container 11, that is, the excreta weight scale 3 has been brought into a state where no load is applied to the excreta weight scale 3. The second threshold M2 is a threshold in accordance with which the detecting section 22 recognizes that the excreta tray 13 on which the absorbing sheet 14 is laid has been inserted in and thereby set in the main container 11, that is, the excreta weight scale 3 has been brought into a state where a load is applied to the excreta weight scale 3 by the excreta tray 13 on which the absorbing sheet 14 is laid, from the state where no load is applied to the excreta weight scale 3.

A value of the first threshold M1 and a value of the second threshold M2 can be each set, by the user, to, for example, any value within a range of (i) the value of the weight of the excreta tray 13 on which the absorbing sheet 14 is not laid to (ii) the value of the weight of the excreta tray 13 on which the absorbing sheet 14 that has absorbed a maximum amount of excreta is laid. Alternatively, the value of the first threshold M1 and the value of the second threshold M2 can be each set in advance as an initial value before the server 5 is shipped from a factory.

In a case where (i) the absorbing sheet 14 which is new and with respect to which the pet has not excreted yet is laid on the excreta tray 13 and then (ii) the excreta tray 13 is inserted into and thereby set in the main container 11, the load is applied to the excreta weight scale 3 due to a weight of the absorbing sheet 14 and the excreta tray 13. This causes the measured value W, which is measured by the excreta weight scale 3, to increase from the initial measured value W0 to a measured value W1, which is a value measured in a case where the excreta tray 13 is set. From this state, each time the pet steps on the excretion stage 12 and excretes, the measured value W, which is measured by the excreta weight scale 3, increases from the measured value W1.

It is assumed that an amount of the excreta absorbed by the absorbing sheet 14 set in the main container 11 has become close to a maximum amount and the measured value W, which is measured by the excreta weight scale 3, has increased to a measured value W2 due to the load applied by the absorbing sheet 14 and the excreta tray 13. In this case, the excreta tray 13 on which the absorbing sheet 14 is laid is detached from the main container 11 by the user for replacement of the absorbing sheet 14.

This causes the measured value W, which is measured by the excreta weight scale 3, to decrease from the measured value W2, which is a value measured immediately before the excreta tray 13 on which the absorbing sheet 14 is laid is detached from the main container 11, to the initial measured value W0, which is a value measured in a state where no load is applied. Here, it is assumed that W2−W0≥M1. In this case, the detecting section 22 determines that a decrease in measured value W from the measured value W2 is equal to or greater than the first threshold M1, and recognizes that the excreta tray 13 on which the absorbing sheet 14 is laid is detached from the main container 11.

Next, by the user, the absorbing sheet 14 which is laid on the excreta tray 13 is replaced with another absorbing sheet 14 which is new and with respect to which the pet has not excreted yet, and the excreta tray 13 on which the another absorbing sheet 14 is laid is inserted into and thereby set in the main container 11. This causes the measured value W, which is measured by the excreta. weight scale 3, to increase from the initial measured value W0, which is a value measured in a state where no load is applied, to the measured value W1. Here, it is assumed that W1−W0≥M2. In this case, the detecting section 22 determines that an increase in measured value Wfrom the initial measured value W0 is equal to or greater than the second threshold M2, and recognizes that the excreta tray 13 on which the another absorbing sheet 14 is laid is set again in the main container 11. The detecting section 22 then subtracts the measured value W1, which is a value measured in a case where the excreta tray 13 on which the absorbing sheet 14 is laid is set again, from the measured value W2, which is a value measured in a case where the excreta tray 13 on which the absorbing sheet 14 is laid is detached. Since W2−W1>0, that is, a value of W2−W1 is positive, the detecting section 22 detects the replacement of the absorbing sheet 14 which has been laid on the excreta tray 13. In this manner, each time the absorbing sheet 14 laid on the excreta tray 13 is replaced, the detecting section 22 detects the replacement of the absorbing sheet 14. Each time the detecting section 22 detects the replacement of the absorbing sheet 14, the counting section 23 counts the replacement, and sequentially stores the number of counts in the storage section 30.

The detecting section 22 thus obtains information indicating the measured value W, which is measured by the excreta weight scale 3 that is used for the pet toilet 1, and detects the replacement of the consumable item, which is used for the pet toilet 1, in a case where the measured value W, which is measured by the excreta weight scale 3, changes by an amount (W2−W1) corresponding to a weight of the consumable item. This makes it possible to detect the replacement of the consumable item, which is used for the pet toilet 1.

Note that the detecting section 22 can be configured to detect the replacement of the consumable item, which is for the pet toilet 1, in a case where the measured value W, which is measured by the excreta weight scale 3, changes by an amount (W2−W0) corresponding to a weight of, out of the pet toilet 1, the consumable item and a member on which the consumable item is laid. That is, a case where the excreta tray 13 is detached from the main container 11 is mainly a case where the absorbing sheet 14 laid on the excreta tray 13 is replaced. Therefore, the detecting section 22 can detect the replacement of the absorbing sheet 14 which has been laid on the excreta tray 13, at a time when the detecting section 22 recognizes that the excreta tray 13 on which the absorbing sheet 14 is laid has been detached from the main container 11. Alternatively, the detecting section 22 can (i) determine that the excretion stage 12 or the upper unit 17 has been detached and (ii) detect the replacement of the litter 16, in a case where the measured value W, which is measured by the excreta weight scale 3, changes by an amount W2−W0. This also allows the detecting section 22 to detect the replacement of the absorbing sheet 14, which is a consumable item.

(Method of Causing Notification to be Sent, Depending on the Number of Consumable Items Kept in Stock)

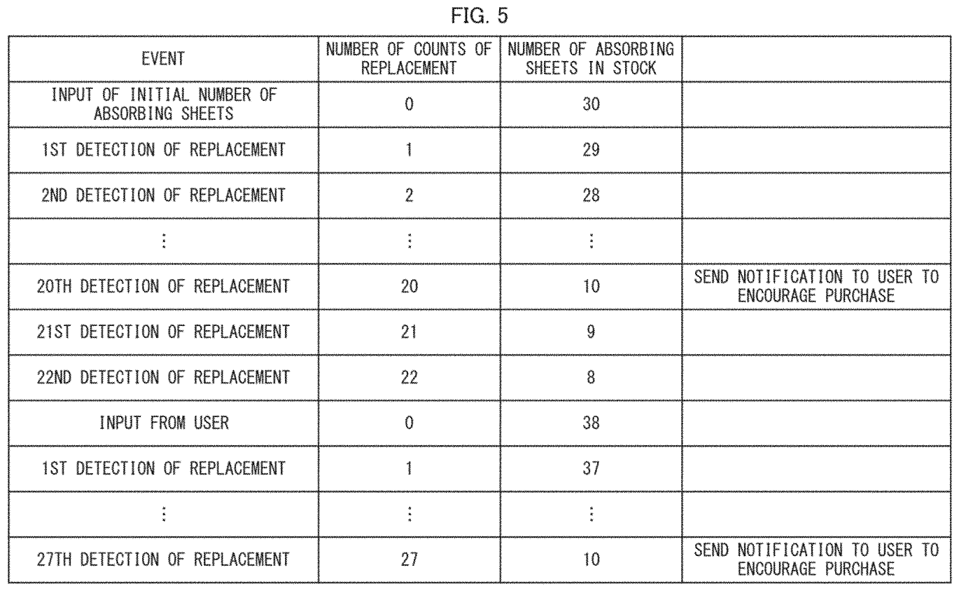

FIG. 5 is a view illustrating a flow along which the notification processing section 24 of the control device 20 in accordance with Embodiment 1 causes the notification to be sent to the user. The storage section 30 stores therein the stock quantity information 31 and the notification set value information 32. The following description will be given on the premise that the number of absorbing sheets 14 kept in stock, out of consumable items kept in stock by the user, is set as the stock quantity information 31. The initial number of absorbing sheets 14 kept in stock is set to 30, and the notification set value is set to 10.

The initial number of absorbing sheets 14 kept in stock and the notification set value can be set as follows. That is, for example, the user inputs, into the smartphone 4, information on the initial number and information on the notification set value. The server 5 obtains those pieces of information via the communication section 45, and stores those pieces of information in the storage section 30. In a case where the pet toilet 1 includes an input device such as a touch panel, the initial number of absorbing sheets 14 kept in stock and the notification set value can be set as follows. That is, the user inputs, into the input device, the information on the initial number and the information on the notification set value. The server 5 obtains those pieces of information via the communication section 45, and stores those pieces of information in the storage section 30.

In a case where the counting section 23 counts the replacement of the absorbing sheet 14, the notification processing section 24 subtracts the number of counts, which have been done by the counting section 23, from the initial number (for example, 30) of absorbing sheets 14 kept in stock, which initial number is stored in the storage section 30. The notification processing section 24 then stores a number, obtained by such a subtraction, in the stock quantity information 31 as the number of absorbing sheets 14 kept in stock.

In a case where the number of absorbing sheets 14 kept in stock, which number is indicated by the stock quantity information 31, decreases to 10, which is the notification set value indicated by the notification set value information 32, the notification processing section 24 determines that a smaller number of absorbing sheets are kept in stock by the user, and causes the notification to be sent to the user so as to encourage purchase of the absorbing sheet 14. This allows the user to recognize that the user keeps a smaller number of absorbing sheets 14 in stock.

In a case where (i) the user purchases a product, containing the absorbing sheet 14, so as to increase the number of absorbing sheets 14 kept in stock and then (ii) the user makes an input, the number of absorbing sheets 14 kept in stock, which number is indicated by the stock quantity information 31, increases. Here, is assumed that the user newly inputs “38” as the number of absorbing sheets 14 kept in stock. In this manner, in a case where the number of absorbing sheets 14 kept in stock increases, the counting section 23 returns the number of counts, done each time the consumable item is replaced, to 0 (zero), and stores, in the storage section 30, the number of counts which number is returned to 0 (zero).

In a case where the number of absorbing sheets 14 kept in stock, which number is indicated by the stock quantity information 31, decreases to 10 again, which is the notification set value indicated by the notification set value information 32, the notification processing section 24 similarly determines that a smaller number of absorbing sheets 14 are kept in stock by the user, and causes the notification to be sent to the user so as to encourage purchase of the absorbing sheet 14.

In this manner, it is possible to encourage the user to purchase the consumable item, in a case where the user keeps a smaller number of consumable items in stock. Therefore, it is possible to prevent the consumable item, kept in stock by the user, from being out of stock.

Note that the notification processing section 24 can be configured, not to cause the notification to be sent to the user in a case where a smaller number of consumable items are left in stock, but to cause the user to be notified of a situation in which the number of consumable items kept in stock gradually decreases from the initial value. For example, the notification processing section 24 can cause the smartphone 4 to display, on a display screen or the like of the smartphone 4, a situation in which the number of consumable items kept in stock decreases from the initial number, depending on the number of counts done each time the consumable item is replaced, as illustrated in FIG. 5.

(Flow of Process Carried Out by Control Device 20)

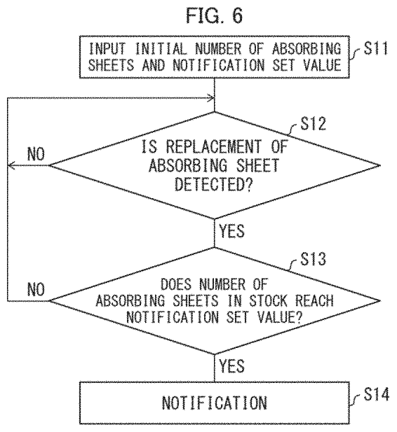

FIG. 6 is a flowchart illustrating a flow of a process carried out by the control device 20 in accordance with Embodiment 1. The control section 21 stores, in the storage section 30, (i) the initial number of consumable items kept in stock and (ii) the notification set value, each of which has been inputted by the user via the smartphone 4 and the communication section 45, as the stock quantity information 31 and the notification set value information 32, respectively (step S11).

Next, the detecting section 22 stands by until the detecting section 22 detects the replacement of the absorbing sheet 14 (step S12). In a case where the detecting section 22 detects the replacement of the absorbing sheet 14 in the step S12 (YES in the step S12), the counting section 23 counts the replacement, and stores the number of counts in the storage section 30. Furthermore, as the number of absorbing sheets 14 kept in stock after the replacement, the counting section 23 stores the number obtained by subtracting the number of counts from the number of absorbing sheets 14 kept in stock which number is indicated by the stock quantity information 31.

Subsequently, the notification processing section 24 determines whether or not the number of absorbing sheets 14 kept in stock, which number is indicated by the stock quantity information 31, reaches the notification set value, which is indicated by the notification set value information 32 (step S13). In a case where, in the step S13, the notification processing section 24 determines that the number of absorbing sheets 14 kept in stock, which number is indicated by the stock quantity information 31, reaches the notification set value, which is indicated by the notification set value information 32 (YES in the step S13), the notification processing section 24 causes the notification to be sent to the user (step S14). As a result, the notification is sent to the user. In a case where, inn the step S13, the notification processing section 24 determines that the number of absorbing sheets 14 kept in stock, which number is indicated by the stock quantity information 31, does not reach the notification set value, which is indicated by the notification set value information 32, a process carried out by the control section 21 returns to the step S12.

As described above, in a case where, in the step S12, the detecting section 22 detects the replacement of the consumable item, which is used for the pet toilet 1 (YES in the step S12), the counting section 23 counts the replacement of the consumable item. In a case where, in the step S13, the notification processing section 24 determines that the number of consumable items kept in stock, which number is indicated by the stock quantity information 31, reaches the notification set value, which is indicated by the notification set value information 32 (YES in the step S13), the notification processing section 24 causes the notification to be sent to the user. That is, the notification processing section 24 causes the user to be notified of information on the consumable item kept in stock by the user, depending on the number of times of replacement of the consumable item. This allows the user to recognize how many consumable items the user keeps in stock. Therefore, it is possible to encourage the user to keep a necessary number of consumable items in stock before the consumable item kept by the user becomes out of stock.

Specifically, in the step S13, in a case where the number of consumable items kept in stock reaches the notification set value (given number), the notification processing section 24 determines that a smaller number of consumable items are kept in stock, and causes the user to be notified of information which encourages replenishment of the consumable item kept in stock. The notification processing section 24 thus estimates that a smaller number of consumable items are left in stock, in a case where the number of consumable items kept in stock reaches the given number, regardless of the number of consumable items kept in stock which number has been inputted by the user. Thereafter, the notification processing section 24 causes the notification to be sent to the user. Therefore, it is possible to encourage the user to keep a necessary number of consumable items in stock before the consumable item kept by the user becomes out of stock.

### Embodiment 2

The following description will discuss Embodiment 2 of the present invention. Note that, for convenience, an identical reference numeral will be given to a member having a function identical to that of a member described inn Embodiment 1, and description of the member will be omitted.

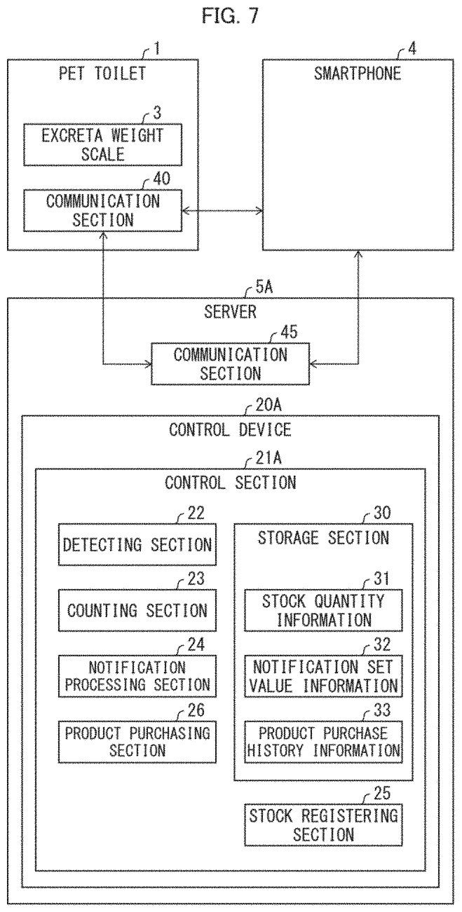

FIG. 7 is a block diagram illustrating a configuration of a pet toilet 1, a smartphone 4, and a server 5A in accordance with Embodiment 2. The server 5A includes a control device 20A, instead of the control device 20 included in the server 5 (see FIG. 3). The control device 20A includes a control section 21A, instead of the control section 21 included in the control device 20. The control section 21A includes a stock registering section 25 and a product purchasing section 26, in addition to the configuration of the control section 21. A storage section 30 further stores therein product purchase history information 33. The other configuration of the server 5A is similar to that of the server 5.

The stock registering section 25 refers to history of user's purchase of a product containing a consumable item (absorbing sheet 14 and/or litter 16), and stores, in the storage section 30, (i) identification information which allows the product to be identified and (ii) the number of consumable items contained in the product, in association with each other, thereby storing the product purchase history information 33, which indicates the history of user's purchase of the product. This allows a user to be saved from registering the number of consumable items kept in stock by the user, each time the user purchases the consumable item. As a result, it is possible to provide the user with enhanced convenience.

For example, it is assumed that the user purchases a product whose product name is “absorbing sheet set” and which contains a set of 30 absorbing sheets 14. In this case, the stock registering section 25 obtains information indicating that history of purchase of the product is stored in the server 5A or the other server. The stock registering section 25 then creates the product purchase history information 33 by associating, for example, the product name “absorbing sheet set”, which serves as identification information that allows the product to be identified, with “30”, which indicates the number of absorbing sheets 14 contained in the product whose product name is “absorbing sheet set”. Note that the identification information which allows the product to be identified is not limited to a product name, provided that the identification information allows the product to be identified. The other examples of the identification information include a product number of the product and a serial number of the product, each of which is given by a manufacturer of the product. Note also that examples of a server inn which the history of user's purchase of the product is stored include: a server of an EC site on which the user has purchased the product; and a server operated by a delivery company which delivers the product that the user has purchased.

In a case where a notification processing section 24 determines that a smaller number of consumable items are kept in stock, the product purchasing section 26 causes the product to be purchased via a telecommunication line such as the Internet, on the basis of the history of user's purchase of the product containing the consumable item. In this manner, the product purchasing section 26 causes the product to be purchased, in a case where a smaller number of consumable items are kept in stock. Therefore, even in a case where the user does not purchase the product, it is possible to keep a sufficient number of consumable items. This allows the user to be saved from purchasing the consumable items to be kept in stock. As a result, it is possible to provide the user with enhanced convenience. Note that the history of user's purchase of the product containing the consumable item can be one that is indicated by the product purchase history information 33 stored in the storage section 30 or can be alternatively one that the user obtains from the server in which the history of user's purchase of the product is stored.

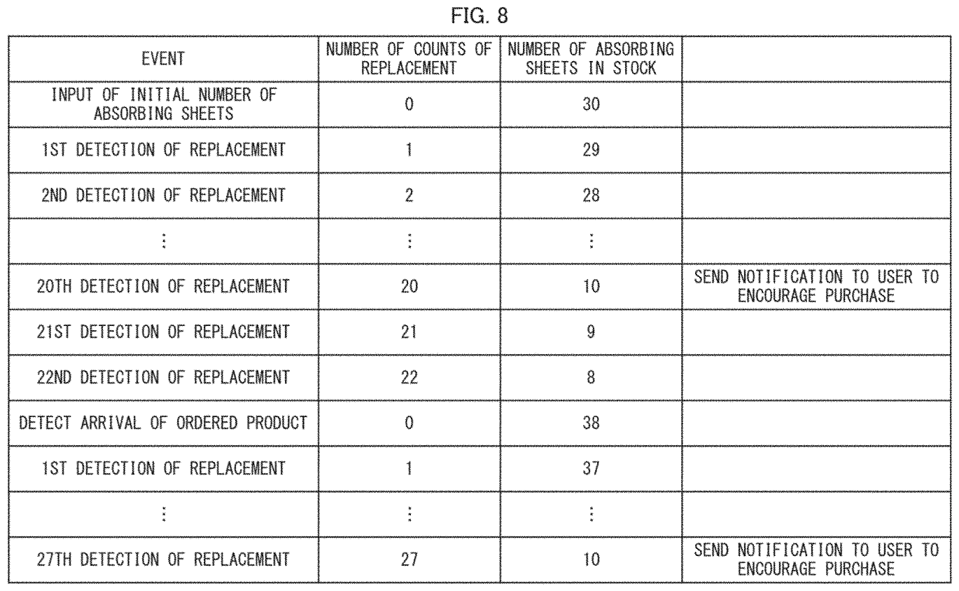

FIG. 8 is a view illustrating a flow along which the control device 20A in accordance with Embodiment 2 registers the number of absorbing sheets 14 kept in stock. The initial number of absorbing sheets 14 kept in stock is set to 30, and a notification set value is set to 10. The initial number of absorbing sheets 14 can be inputted by the user or can be registered by the stock registering section 25 in a case where it is possible for the stock registering section 25 to obtain history of user's purchase of a product containing the absorbing sheet 14. Note that the notification set value is inputted by the user.

In a case where a counting section 23 counts replacement of the absorbing sheet 14, the notification processing section 24 subtracts the number of counts, which have been done by the counting section 23, from the initial number (for example, 30) of absorbing sheets 14 kept in stock, which initial number is stored in the storage section 30. The notification processing section 24 then stores a number, obtained by such a subtraction, in stock quantity information 31 as the number of absorbing sheets 14 kept in stock.

In a case where the number of absorbing sheets 14 kept in stock, which number is indicated by the stock quantity information 31, decreases to 10, which is the notification set value indicated by notification set value information 32, the notification processing section 24 determines that a smaller number of absorbing sheets 14 are kept in stock by the user, and causes a notification to be sent to the user so as to encourage purchase of the absorbing sheet 14.

Furthermore, in case where the notification processing section 24 determines that a smaller number of absorbing sheets 14 are kept in stock by the user, the product purchasing section 26 causes the product to be purchased via the telecommunication line such as the Internet on the basis of the history of user's purchase of the product containing the absorbing sheet 14. Thus, the product is purchased. Here, it is assumed that the product containing a set of 30 absorbing sheets 14 is purchased. Then, the product purchasing section 26 notifies the stock registering section 25 of a fact that the product has been purchased.

The stock registering section 25 then monitors the number of days in which the product having been purchased arrives on the user. In a case where the product having been purchased arrives on the user, the stock registering section 25 determines that the product has arrived on the user. As a method by which the stock registering section 25 monitors the number of days in which the product having been purchased arrives on the user, the following method can be employed. For example, the stock registering section 25 refers to a server operated by a delivery company which delivers the product having been purchased, and refers to the number of days in which the product having been purchased arrives on the user.

In a case where the stock registering section 25 determines that the product has arrived on the user, the stock registering section 25 adds “30”, which is the number of absorbing sheets 14 contained in the product, to the number of absorbing sheets 14 kept in stock, which number is stored in the storage section 30, so as to update the number of absorbing sheets 14 kept in stock, which number is indicated by the stock quantity information 31. The counting section 23 returns the number of counts to 0 (zero).

In a case where the number of absorbing sheets 14 kept in stock, which number is indicated by the stock quantity information 31, decreases to 10 again, which is the notification set value indicated by the notification set value information 32, the notification processing section 24 similarly determines that a smaller number of absorbing sheets 14 are kept in stock by the user, and causes the notification to be sent to the user so as to encourage purchase of the absorbing sheet 14. Furthermore, in a case where the notification processing section 24 determines that a smaller number of absorbing sheets 14 are kept in stock by the user, the product purchasing section 26 causes the product containing the absorbing sheet 14 to be purchased on the basis of the history of user's purchase of the product containing the absorbing sheet 14.

Note that, in a case where the notification processing section 24 determines that a smaller number of absorbing sheets 14 are kept in stock by the user, not the product purchasing section 26 but the user can purchase the product containing the absorbing sheet 14 by him-/herself. Also in this case, the stock registering section 25 monitors the number of days in which the product having been purchased arrives on the user, on the basis of the history of user's purchase of the product. In a case where the product having been purchased arrives on the user, the stock registering section 25 determines that the product has arrived on the user. In a case where the stock registering section 25 determines that the product has arrived on the user, the stock registering section 25 then adds the number of absorbing sheets 14 contained in the product, to the number of absorbing sheets 14 kept in stock, which number is stored in the storage section 30, so as to update the number of absorbing sheets 14 kept in stock, which number is indicated by the stock quantity information 31. The counting section 23 then returns the number of counts to 0 (zero).

Alternatively, the number of absorbing sheets 14 kept in stock, which number is indicated by the stock quantity information 31 can be updated as follows. That is, in a case where the notification processing section 24 determines that a smaller number of absorbing sheets 14 are kept in stock by the user, the product purchasing section 26 causes the product containing the absorbing sheet 14 to be purchased. In a case where the product having been purchased arrives on the user, not the stock registering section 25 but the user updates, by him-/herself, the number of absorbing sheets 14 kept in stock, which number is indicated by the stock quantity information 31. In a case where the number of absorbing sheets 14 kept in stock, which number is indicated by the stock quantity information 31 is updated, the counting section 23 returns the number of counts to 0 (zero).

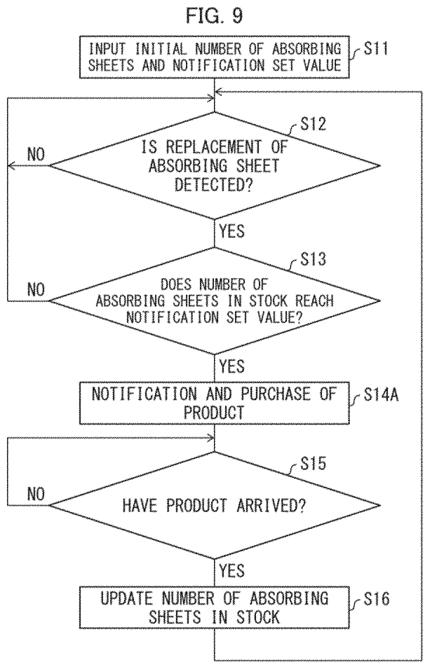

FIG. 9 is a flowchart illustrating a flow of a process carried out by the control device 20A in accordance with Embodiment 2. It is assumed that steps S11 through S13 are carried out and then, in the step S13, the notification processing section 24 determines that the number of absorbing sheets 14 kept in stock, which number is indicated by the stock quantity information 31, reaches the notification set value, which is indicated by the notification set value information 32 (YES in the step S13). In this case, the notification processing section 24 causes the notification to be sent to the user, and the product purchasing section 26 causes the product to be purchased, on the basis of the history of user's purchase of the product containing the absorbing sheet 14 (step S14A). Subsequently, the stock registering section 25 determines whether or not the product having been purchased has arrived on the user (step S15). In the step S15, in a case where the stock registering section 25 determines that the product having been purchased has arrived on the user (YES in the step S15), the stock registering section 25 updates the number of absorbing sheets 14 kept in stock, which number is stored in the storage section 30 (step S16).

### Embodiment 3

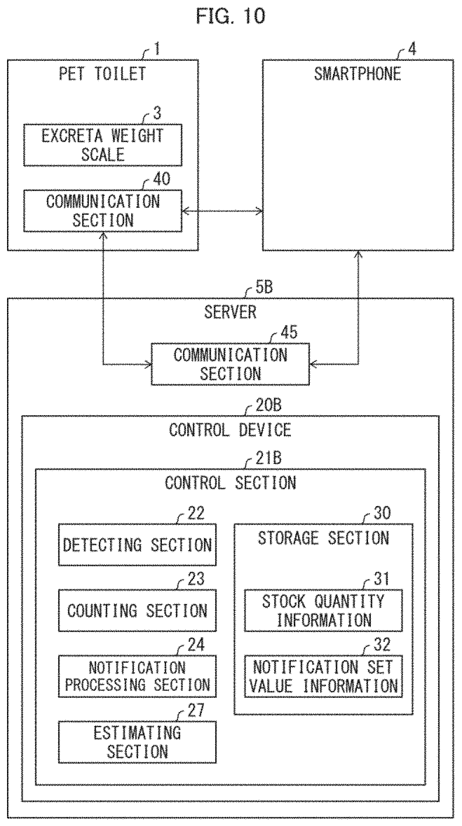

The following description will discuss Embodiment 3 of the present invention. Note that, for convenience, an identical reference numeral will be given to a member having a function identical to that of a member described in Embodiment 1 or 2, and description of the member will be omitted. FIG. 10 is a block diagram illustrating a configuration of a pet toilet 1, a smartphone 4, and a server 5B in accordance with Embodiment 3.

The server 5B includes a control device 20B, instead of the control device 20 included in the server 5 (see FIG. 3). The control device 20B includes a control section 21B, instead of the control section 21 included in the control device 20. The control section 21B includes an estimating section 27, in addition to the configuration of the control section 21.

The estimating section 27 estimates the number of days in which a consumable item becomes out of stock, in accordance with (i) a change in number of times of replacement of the consumable item and (ii) the number of consumable items kept in stock, which number is stored in a storage section 30. In a case where the number of days in which the consumable item becomes out of stock, which number is estimated by the estimating section 27, is equal to or lower than a given number, a notification processing section 24 determines that a smaller number of consumable items are kept in stock, and causes a user to be notified of information which encourages replenishment of the consumable item kept in stock. This makes it possible to encourage the user to keep a necessary number of consumable items in stock before the consumable item kept by the user becomes out of stock. Note that the given number, with reference to which the notification processing section 24 determines that a smaller number of consumable items are kept in stock, is set to any number by the user, and is stored in the storage section 30

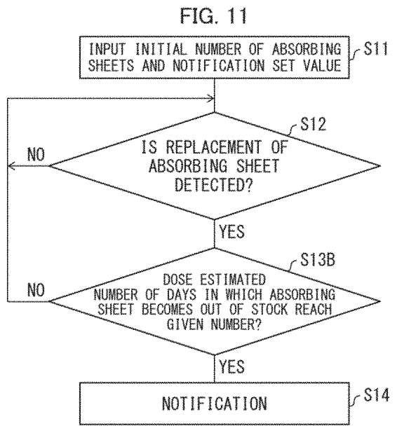

FIG. 11 is a flowchart illustrating a flow of a process carried out by the control device 20B in accordance with Embodiment 3. Steps S11 and S12 are carried out. In the step S12, in a case where a detecting section 22 detects replacement of an absorbing sheet 14 (YES in the step S12), the estimating section 27 estimates the number of days in which the absorbing sheet 14 becomes out of stock, in accordance with (i) an interval(s) between detection of replacement of the absorbing sheet 14 and subsequent detection of replacement of the absorbing sheet 14 and (ii) the number of absorbing sheets 14 kept in stock, which number is stored in the storage section 30. The notification processing section 24 then determines whether or not the number of days which number is estimated by the estimating section 27 reaches the given number (step S13B). In a case where, in the step S13B, the notification processing section 24 determines that the number of days which number is estimated by the estimating section 27 reaches the given number (YES in the step S13B), the notification processing section 24 causes a notification to be sent to the user (step S14). In a case where, in the step S13B, the notification processing section 24 determines that the number of days which number is estimated by the estimating section 27 does not reach the given number (NO in the step S138), the process carried out by the control section 21B returns to the step S12.

### Embodiment 4

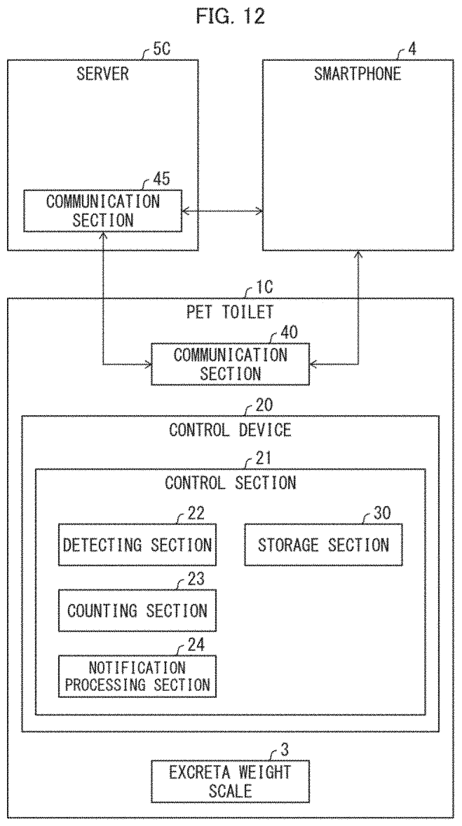

The following description will discuss Embodiment 4 of the present invention. Note that, for convenience, an identical reference numeral will be given to a member having a function identical to that of a member described in any one of Embodiments 1 through 3, and description of the member will be omitted. FIG. 12 is a block diagram illustrating a configuration of a pet toilet 1C, a smartphone 4, and a server 5C in accordance with Embodiment 4. The pet toilet 1C includes a control device 20, in addition to the configuration of the pet toilet 1. The server 5C is configured not to include the control device 20 included in the server 5. In this manner, the control device 20 can be provided, not to the server 5, but to the pet toilet 1C.

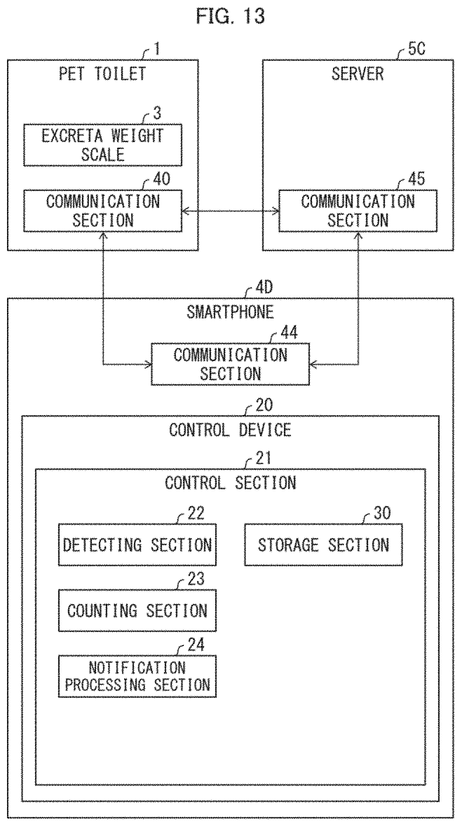

FIG. 13 is a block diagram illustrating a configuration of a pet toilet 1, a smartphone 4D, and a server 5C in accordance with another aspect of Embodiment 4. The smartphone 4D includes a control device 20 and a communication section 44, in addition to the configuration of the smartphone 4. In this manner, the control device 20 can be provided, not to the pet toilet 1C nor to the server 5, but to the smartphone 4D. The communication section 44 conducts communication with the server 5C via a telecommunication line such as the Internet. The communication section 44 can conduct communication with a communication section 40 of the pet toilet 1 via a telecommunication line such as the Internet or can alternatively conduct near field communication with the communication section 40.

### Software Implementation Example

A control block (particularly, the detecting section 22, the counting section 23, and the notification processing section 24) of the control device 20 can be realized by a logic circuit (hardware) provided on, for example, an integrated circuit (IC chip) or can be alternatively realized by software.

In the latter case, the control device 20 includes a computer which executes instructions of a program that is software realizing the foregoing functions. The computer includes, for example, at least one processor (control device) and at least one computer-readable storage medium which stores therein the program. By, in the computer, the processor reading the program from the storage medium and executing the program, the object of an aspect of the present invention is attained. Examples of the processor include central processing units (CPUs). Examples of the storage medium include “non-transitory tangible mediums” such as a tape, a disk, a card, a semiconductor memory, and a programmable logic circuit, as well as a read only memory (ROM). The computer can further include a random access memory (RAM) or the like in which the program is loaded. The program can be supplied to or made available to the computer via any transmission medium (such as a communication network or a broadcast wave) which allows the program to be transmitted. Note that an aspect of the present invention can also be achieved in the form of a computer data signal in which the program is embodied via electronic transmission and which is embedded in a carrier wave.

Note that the present invention is not limited to the embodiments, but can be altered by a skilled person in the art within the scope of the claims. The present invention also encompasses, in its technical scope, any embodiment derived by combining technical means disclosed in differing embodiments. Further, it is possible to form a new technical feature by combining the technical means disclosed in the respective embodiments.

### REFERENCE SIGNS LIST

1, 1C Pet toilet (animal toilet)
2 Body weight scale
3 Excreta weight scale (weight scale)
4, 4D Smartphone
5, 5A through 5C Server
11 Main container
12 Excretion stage
13 Excreta tray
14 Absorbing sheet (consumable item
15 Supporting plate
16 Litter (consumable item)
20, 20A, 20B Control device
21, 21A, 21B Control section
22 Detecting section
23 Counting section
24 Notification processing section
25 Stock registering section
26 Product purchasing section
27 Estimating section
30 Storage section
31 Stock quantity information
32 Notification set value information
33 Product purchase history information
40, 44, 45 Communication section
M1 First threshold
M2 Second threshold

1. A control device which controls an animal toilet, the control device comprising:
a detecting section which detects replacement of a consumable item that is an item used for the animal toilet;
a counting section which counts the replacement of the consumable item; and
a notification processing section which causes a user to be notified of information on the consumable item kept in stock, depending on the number of times of the replacement.

2. The control device as set forth in claim 1, wherein in a case where the number of consumable items kept in stock reaches a given number, the notification processing section determines that a smaller number of consumable items are kept in stock, and causes the user to be notified of information which encourages replenishment of the consumable item kept in stock.

3. The control device as set forth in claim 1, further comprising
an estimating section which estimates the number of days in which the consumable item becomes out of stock, in accordance with (i) a change in number of times of the replacement of the consumable item and (ii) the number of consumable items kept in stock, which number is stored in a storage section,
in a case where the number of days in which the consumable item becomes out of stock is equal to or lower than a given number, the notification processing section determines that a smaller number of consumable items are kept in stock, and causes the user to be notified of information which encourages replenishment of the consumable item kept in stock.

4. The control device as set forth in claim 3, further comprising a stock registering section which refers to history of user's purchase of a product containing the consumable item, and stores, in the storage section, (i) identification information which allows the product to be identified and (ii) the number of consumable items contained in the product, in association with each other.

5. The control device as set forth in claim 2, further comprising a product purchasing section which causes a product containing the consumable item to be purchased via a telecommunication line, on the basis of history of user's purchase of the product, in a case where the notification processing section determines that a smaller number of consumable items are kept in stock.

6. The control device as set forth in claim 1, wherein the detecting section obtains information indicating a value measured by a weight scale, which is a weight scale used for the animal toilet, and detects the replacement of the consumable item, which is an item used for the animal toilet, in a case where the value measured by the weight scale changes by an amount corresponding to a weight of the consumable item.

7. The control device as set forth in claim 1, wherein the detecting section obtains information indicating a value measured by a weight scale, which is a weight scale used for the animal toilet, and detects the replacement of the consumable item, which is an item used for the animal toilet, in a case where the value measured by the weight scale changes by an amount corresponding to a weight of, out of the animal toilet, the consumable item and a member on which the consumable item is laid.

8. The control device as set forth in claim 1, wherein the consumable item is a sheet which absorbs urine.

9. The control device as set forth in claim 1, wherein the consumable item is litter onto which an animal that uses the animal toilet steps.

10. An animal toilet comprising:
the control device recited in claim 1; and
a weight scale which measures a weight of the consumable item.

11. An information processing device comprising
the control device recited in claim 1,
the detecting section detects the replacement of the consumable item on the basis of an output signal outputted from the animal toilet.

12. An information processing terminal comprising
the control device recited in claim 1,
the detecting section detects the replacement of the consumable item included in the animal toilet.

13. A method of controlling an animal toilet, the method comprising:
a detecting step of detecting replacement of a consumable item which is an item used for the animal toilet;
a counting step of counting the replacement of the consumable item; and
a notification processing step of causing a user to be notified of information on the consumable item kept in stock, depending on the number of times of the replacement.
